(19) United States
(12) Patent Application Publication
(10) Pub. No.: US 2016/0203274 A1
(43) Pub. Date: Jul. 14, 2016

(54) NON-TRANSITORY COMPUTER-READABLE RECORDING MEDIUM, RETRIEVAL METHOD, AND RETRIEVAL APPARATUS

(71) Applicant: FUJITSU LIMITED, Kawasaki-shi (JP)

(72) Inventor: TATSUO HAYAKAWA, Toyoake (JP)

(73) Assignee: FUJITSU LIMITED, Kawasaki-shi (JP)

(21) Appl. No.: 15/080,124

(22) Filed: Mar. 24, 2016

Related U.S. Application Data
(63) Continuation of application No. PCT/JP2013/077171, filed on Oct. 4, 2013.

(51) Int. Cl. G06F 19/00; G06F 17/30

(52) U.S. Cl. CPC G06F 19/322; G06F 17/30595; G06F 17/30312; G06F 17/30418

(57) ABSTRACT

A retrieval apparatus reads information that identifies a user, information about any one of an action performed on the user and an action performed by the user, and date and time information from data base, generates a data string that is obtained by combining the information that identifies a user, the information about any one of an action performed on the user and an action performed by the user, and the date and time information, for a plurality of data records that are stored in the database, stores the data strings in a memory, accepts specification of information that identifies a user, a retrieval target period, and information about an action of the user and retrieves a data string corresponding to the specification from among the data strings stored in the memory.

### CROSS-REFERENCE TO RELATED APPLICATION(S)

This application is a continuation of International Application No. PCT/JP2013/077171, filed on Oct. 4, 2013, the entire contents of which are incorporated herein by reference.

### FIELD

The embodiment discussed herein is related to a retrieval program and the like.

### BACKGROUND

In recent years, to give information about a patient to a doctor, a system of displaying information on a patient's history chronologically, aligning multiple items has been considered. When information on a patient's history is displayed in chronological order, processing of reading information about the patient from a database is performed.

For example, when information about a patient is stored in a database in an existing relational database format, a structured query language (SQL) command is used to read the information about the patient from the database. In SQL, an SQL command specifying an item is issued per item desired to be extracted (Japanese Laid-open Patent Publication No. 2001-155100, Japanese Laid-open Patent Publication No. 2011-113486, and Japanese Laid-open Patent Publication No. 2009-175981).

### SUMMARY

According to an aspect of an embodiment, a non-transitory computer-readable recording medium stores therein a program that causes a computer to execute a process including: reading information that identifies a user, information about any one of an action performed on the user and an action performed by the user, and date and time information from data base; generating a data string that is obtained by combining the information that identifies a user, the information about any one of an action performed on the user and an action performed by the user, and the date and time information, for a plurality of data records that are stored in the database; storing the data strings generated in the generating in a memory; accepting specification of information that identifies a user, a retrieval target period, and information about an action of the user; and retrieving a data string corresponding to the specification from among the data strings stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a functional block diagram depicting a configuration of a retrieval apparatus according to a present embodiment;

FIG. 2 is diagram (1) depicting one example of a data configuration of first electronic patient-chart information;

FIG. 3 is diagram (2) depicting one example of a data configuration of the first electronic patient-chart information;

FIG. 4 is diagram (3) depicting one example of a data configuration of the first electronic patient-chart information;

FIG. 5 depicts one example of a data configuration of second electronic patient-chart information;

FIG. 6 depicts one example of a data configuration of key-pattern definition information;

FIG. 7 is a diagram for explaining one example of processing performed by a generating unit;

FIG. 8 is a diagram for explaining one example of a retrieval key that is generated by the retrieving unit;

FIG. 9 is a flowchart indicating a processing procedure of generating the second electronic patient-chart information by the retrieval apparatus;

FIG. 10 is a flowchart indicating a processing procedure of retrieving by the retrieval apparatus; and

FIG. 11 depicts one example of a computer that executes a retrieval program.

### DESCRIPTION OF EMBODIMENT(S)

However, in the conventional technique described above, there has been a problem that desired information is not be acquired from a database.

Because an item is specified to extract information about a patient in SQL, processing itself requires time. Therefore, for example, when information on a patient's history is to be displayed chronologically, aligning multiple items, it takes time until a retrieval result is displayed from when a display request is made.

Moreover, when it is desired to display information while switching time axes as “entire period”, “10 years”, “1 year”, and “monthly”, database retrieval is to be performed per each period, and even more time is required.

Preferred embodiments of the present invention will be explained with reference to accompanying drawings. The present invention is not limited to the embodiment.

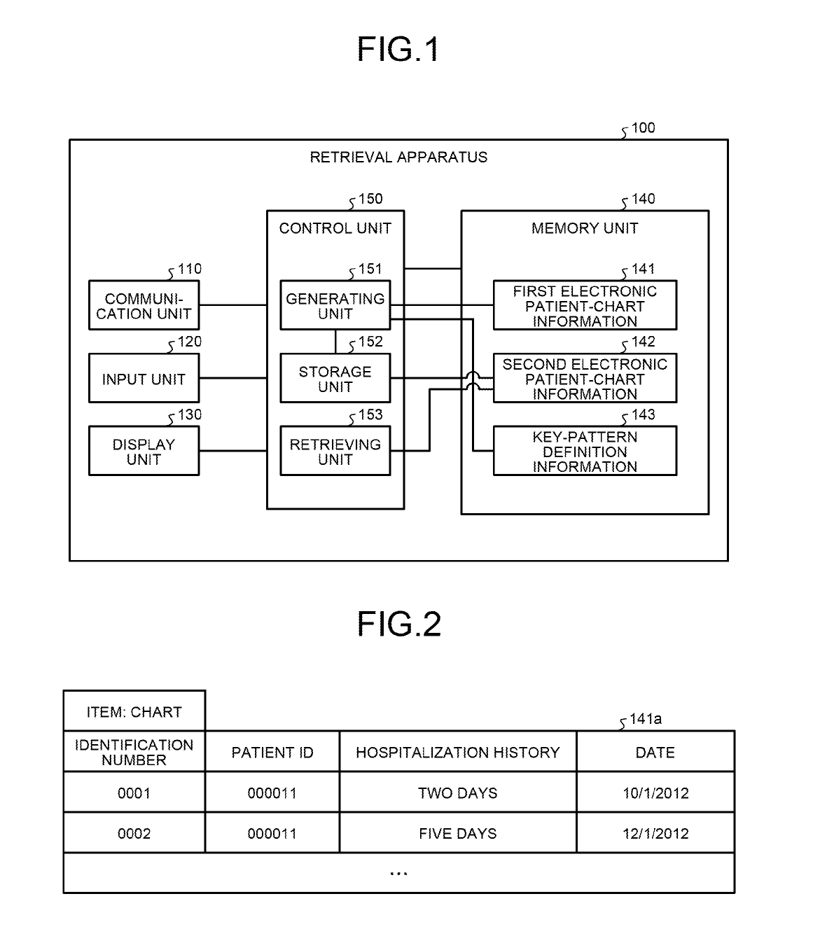

A configuration of a retrieval apparatus according to a present embodiment is explained. FIG. 1 is a functional block diagram depicting a configuration of the retrieval apparatus according to the present embodiment. As depicted in FIG. 1, this retrieval apparatus 100 includes a communication unit 110, an input unit 120, a display unit 130, a memory unit 140, and a control unit 150.

The communication unit 110 is a processing unit that performs data communication with other external devices through a network. The communication unit 110 corresponds to a communication device.

The input unit 120 is an input device that inputs various kinds of information. For example, the input unit 120 corresponds to a keyboard, a mouse, a touch panel, and the like.

The display unit 130 is a display device that displays information output from the control unit 150. For example, the display unit 130 corresponds to a monitor, a liquid crystal display, and the like.

The memory unit 140 includes first electronic patient-chart information 141, second electronic patient-chart information 142, and key-pattern definition information 143. The memory unit 140 corresponds to, for example, a storage device such as a semiconductor memory device including a random access memory (RAM), a read-only memory (ROM), a flash memory, and the like.

The first electronic patient-chart information 141 has information relating to diseases a patient had, a chart of the patient, and a medical practice that has been applied to the patient. For example, the medical practice includes prescription, treatment, operation, examination, injection, transfusion, and the like.

FIG. 2 to FIG. 4 are diagrams depicting one example of a data configuration of the first electronic patient-chart information. For example, the first electronic patient-chart information 141 includes tables 141a to 141c depicted in FIG. 2 to FIG. 4. The first electronic patient-chart information 141 may include a table other than the tables 141a to 141c depicted in FIG. 2 to FIG. 4.

The table 141a in FIG. 2 is explained. The table 141a holds information relating to patient charts. To an item of the table 141a, “chart” is set. The table 141a associates an identification number, a patient identification (ID), a hospitalization history, and a date. The identification number is information that uniquely identifies each record in the table 141a. The patient ID is information that uniquely identifies a patient. The hospitalization history indicates, for example, a history of a period that a patient is in hospital. The data corresponds to a date of the first day of a period that a patient is in hospital.

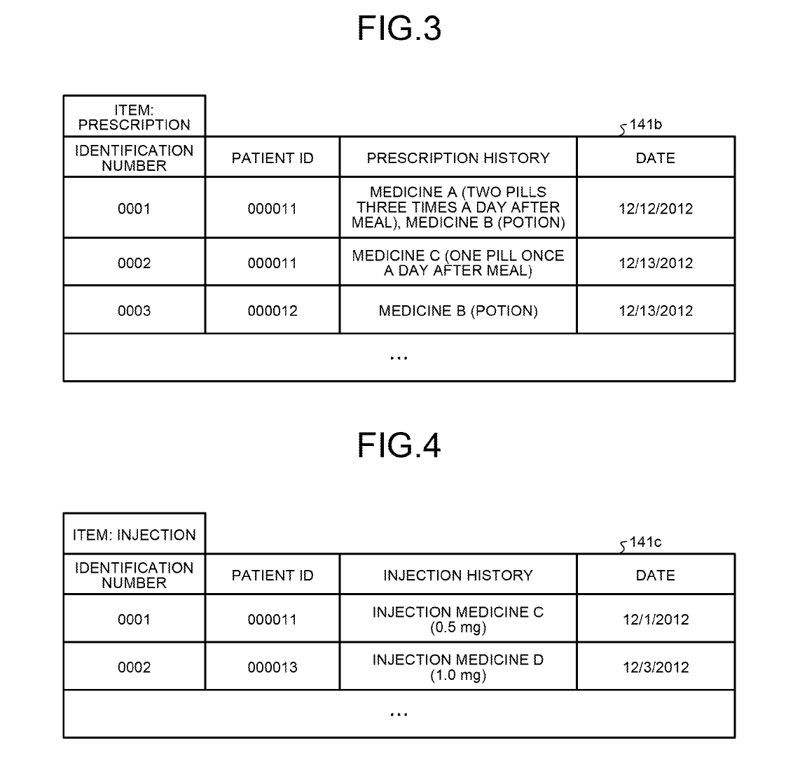

A table 141b in FIG. 3 is explained. The table 141b holds information relating to prescription given to a patient. To an item of the table 141b, “prescription” is set. The table 141b associates an identification number, a patient ID, a prescription history, and a date. The identification number is information that uniquely identifies each record in the table 141b. The patient ID is information that uniquely identifies a patient. The prescription history indicates a history of prescription given to a patient. The date indicates a date on which a prescription is given to a patient.

The table 141c in FIG. 4 is explained. The Table 141c holds information relating to injection given to a patient. To an item of the table 141c, “injection” is set. The table 141c associates an identification number, a patient ID, an injection history, and a data. The identification number is information that uniquely identifies each record in the table 141c. The patient ID is information that uniquely identifies a patient. The injection history indicates a history of injection given to a patient. The date indicates a date on which an injection is given to a patient.

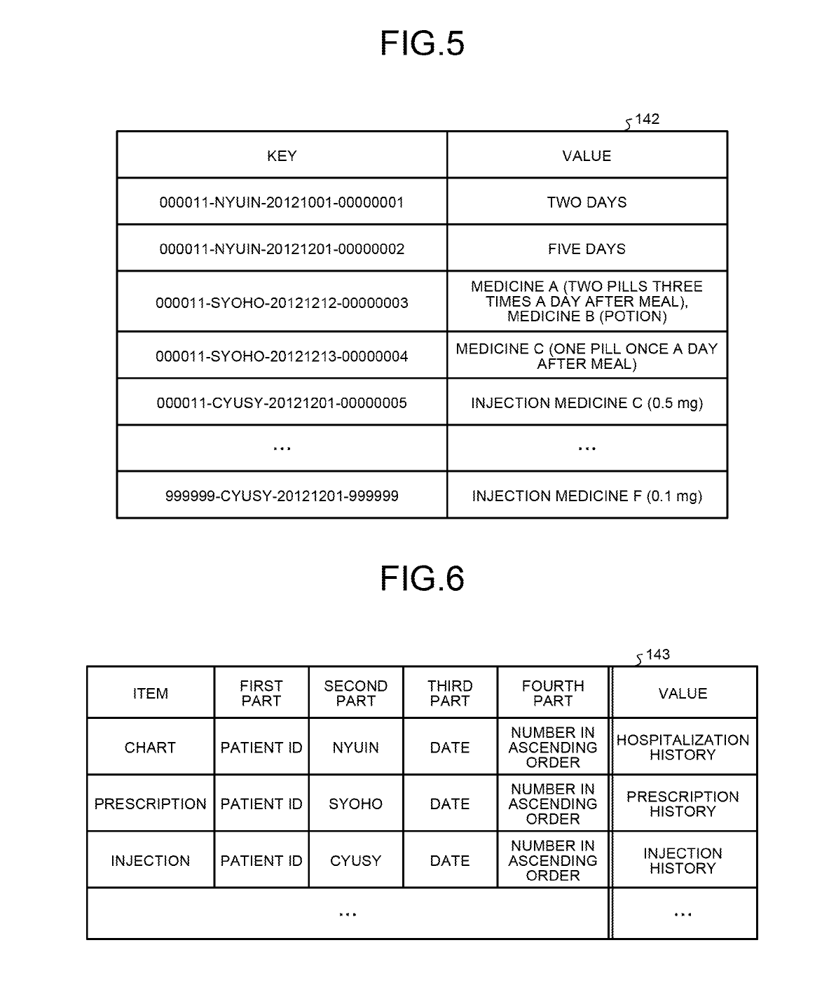

Explanation returns to FIG. 1. The second electronic patient-chart information 142 is data that is generated based on the first electronic patient-chart information 141 and the key-pattern definition information 143. FIG. 5 depicts one example of a data configuration of the second electronic patient-chart information. As depicted in FIG. 5, this second electronic patient-chart information 142 includes a key and a value. The key is divided into a first part, a second part, a third part, and a fourth part by hyphens “-”. For example, as for a key “000011-NYUIN-20121001-00000001”, the first part corresponds to “0000011”. The second part corresponds to “NYUIN”. The third part corresponds to “20121001”. The fourth part corresponds to “00000001”. How a key and a value corresponds to the key are set is defined by the key-pattern definition information 143.

The key-pattern definition information 143 is information that defines how a key in the second electronic patient-chart information 142 is generated is defined. FIG. 6 depicts one example of a data configuration of the key-pattern definition information. As depicted in FIG. 6, this key-pattern definition information 143 associates an item, a first part, a second part, a third part, a fourth part, and a value.

In FIG. 6, an item is to identify each table of the first electronic patient-chart information 141. For example, an item “chart” indicates the table 141a, an item “prescription” indicates the table 141b, and an item “injection” indicates the table 141c.

In FIG. 6, when a key is generated for the item “chart”, the first part is “patient ID”, the second part is “NYUIN”, the third part is “date”, the fourth part is “number in ascending order”, and the value associated with the key is “hospitalization history”. For example, when a key and a value are generated from a first row of the table 141a based on the key-pattern definition information 143, the key is “000011-NYUIN-20121001-00000001”, and the value is “two days”. As for “number in ascending order” is to set a value obtained by adding 1 every time a key is generated from an initial value “00000000”, to the fourth part.

In FIG. 6, when a key is generated for the item “prescription”, the first part is “patient ID”, the second part is “SYOHO”, the third part is “date”, the fourth part is “number in ascending order”, and the value associated with the key is “prescription history”. For example, when a key and a value are generated from a first row of the table 141b based on the key-pattern definition information 143, the key is “000011-SYOHO-20121212-00000003”, and the value is “medicine A (two pills three times a day after meal), medicine B (potion)”.

In FIG. 6, when a key is generated for the item “injection”, the first part is “patient ID”, the second part is “CYUSY”, the third part is “date”, the fourth part is “number in ascending order”, and the value associated with the key is “injection history”. For example, when a key and a value are generated from a first row of the table 141c based on the key-pattern definition information 143, the key is “000011-CYUSY-20121201-00000005”, and the value is “injection medicine C (0.5 mg)”.

The control unit 150 includes a generating unit 151, a storage unit 152, and a retrieving unit 153. The control unit 150 corresponds to an integrated device such as an application specific integrated circuit (ASIC) and a field programmable gate array (FPGA). Furthermore, the control unit 150 corresponds to, for example, an electronic circuit such as a central processing unit (CPU) and a micro processing unit (MPU).

The generating unit 151 is a processing unit that generates a key and a value of the second electronic patient-chart information 142 based on the first electronic patient-chart information 141 and the key-pattern definition information 143. The generating unit 151 outputs a set of the generated key and value to the storage unit 152.

One example of processing performed by the generating unit 151 is explained. The generating unit 151 refers to the first electronic patient-chart information 141, and selects a table included in the first electronic patient-chart information 141. The generating unit 151 compares an item of the selected table and a record of the key-pattern definition information 143 corresponding to the item, and generates a key.

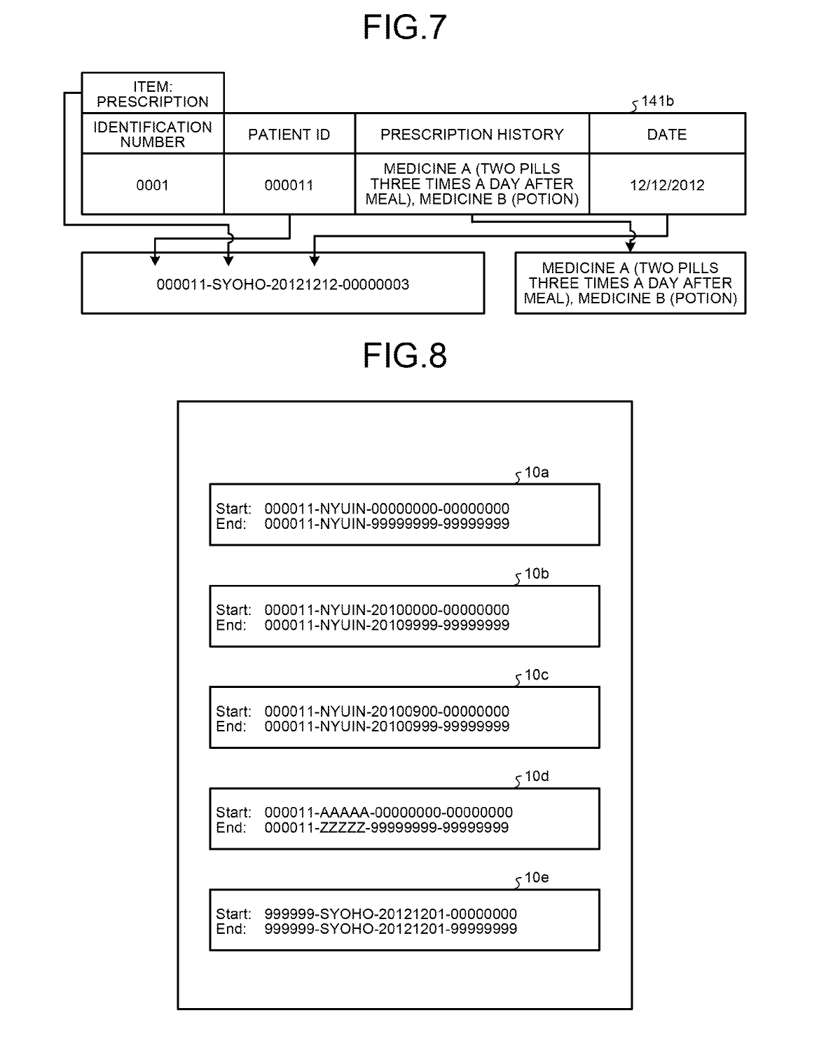

FIG. 7 is a diagram for explaining one example of processing performed by the generating unit. In FIG. 7, a case in which a key and a value of a record corresponding to an identification number “0001” of the table 141b are generated is explained as an example. The item of the table 141b is “prescription”. Therefore, the generating unit 151 sets a key and a value based on a record corresponding to the item “prescription” of the key-pattern definition information 143. Specifically, the generating unit 151 sets “000011” to the first part of the key, “SYOHO” to the second part, “20121212” to the third part, and “00000003” to the fourth part, for example. Moreover, the generating unit 151 generates the value “medicine A (two pills three times a day after meal), medicine B (potion)”. The generating unit 151 outputs a set of the generate key and value to the storage unit 152.

The generating unit 151 generates a key and a value for each record of each table included in the first electronic patient-chart information 141, and outputs a set of the generated key and value to the storage unit 152. When the first electronic patient-chart information 141 is updated, the generating unit 151 generates difference information of the first electronic patient-chart information 141 before update and the first electronic patient-chart information 141 after update, and generates a key and a value for an updated record based on the generated difference information.

The storage unit 152 is a processing unit that acquires the set of a key and a value from the generating unit 151, and stores the acquired set of a key and a value in the second electronic patient-chart information 142.

The retrieving unit 153 is a processing unit that generates, when accepting a retrieval condition from the input unit 120, a retrieval key, compares the retrieval key and the second electronic patient-chart information 142, and retrieves a key and a value that correspond to the retrieval key. For example, a user operates the input unit 120 to input a retrieval condition. The retrieving unit 153 generates a retrieval key by using a correspondence table in which the given retrieval condition and a retrieval key generated based on the retrieval condition are associated.

One example of a retrieval key generated by the retrieving unit 153 is explained. FIG. 8 is a diagram for explaining one example of a retrieval key that is generated by the retrieving unit. In FIG. 8, a retrieval key 10a is a retrieval key that is generated when the patient ID “000011” and the item “chart” are specified as a retrieval condition. The retrieving unit 153 retrieves a key included in “000011-NYUIN-00000000-00000000” to “000011-NYUIN-99999999-99999999” and a value that is associated with the key, from the second electronic patient-chart information 142. That is, the retrieving unit 153 uses the retrieval key 10a, thereby retrieving a key in which the first part is “000011” and the second part is “NYUIN”, and a value that is associated with the key, from the second electronic patient-chart information 142. By the retrieval key 10a, information relating to a patient chart of the patient ID “000011” can be retrieved from the second electronic patient-chart information 142.

A retrieval key 10b is a retrieval key that is generated when the patient ID “000011”, the item “chart” and a year “2010” are specified as a retrieval condition. The retrieving unit 153 retrieves a key included in “000011-NYUIN-20100000-00000000” to “000011-NYUIN-20109999-99999999” and a value that is associated with the key, from the second electronic patient-chart information 142. That is, the retrieving unit 153 uses the retrieval key 10b, thereby retrieving a key in which the first part is “000011”, the second part is “NYUIN”, and a first four digits of the third part is “2010” and a value that is associated with the key, from the second electronic patient-chart information 142. By the retrieval key 10b, information relating to a patient chart of the patient ID “000011” of the year 2010 can be retrieved from the second electronic patient-chart information 142.

A retrieval key 10c is a retrieval key that is generated when the patient ID “000011”, the item “chart”, and a month and a year “September, 2010” are specified as a retrieval condition. The retrieving unit 153 retrieves a key included in “000011-NYUIN-20100900-00000000” to “000011-NYUIN-20100999-99999999” and a value that is associated with the key, from the second electronic patient-chart information 142. That is, the retrieving unit 153 uses the retrieval key 10c, thereby retrieving a key in which the first part is “000011”, the second part is “NYUIN”, and first six digits of the third part is “201009”, and a value that is associated with the key, from the second electronic patient-chart information 142. By the retrieval key 10c, information relating to a patient chart of the patient ID “000011” of September, 2010 can be retrieved from the second electronic patient-chart information 142.

A retrieval key 10d is a retrieval key that is generated when the patient ID “000011” is specified. The retrieving unit 153 retrieves a key included in “000011-AAAAA-00000000-00000000” to “000011-ZZZZZ-99999999-99999999” and a value that is associated with the key, from the second electronic patient-chart information 142. That is, the retrieving unit 153 retrieves a key in which the first part is “000011”, and a value that is associated with the key, from the second electronic patient-chart information 142. By the retrieval key 10d, all information relating to the patient ID “000011” can be retrieved from the second electronic patient-chart information 142.

A retrieval key 10e is a retrieval key that is generated when a year and a date “12/1/2012” and the item “prescription” are specified as a retrieval condition. The retrieving unit 153 uses the retrieval key 10e, thereby retrieving a key included in “000000-SYOHO-20121201-00000000” to “999999-SYOHO-20121201-99999999” and a value that is associated with the key, from the second electronic patient-chart information 142. That is, the retrieving unit 153 retrieves a key in which the second part is “SYOHO” and the third part is “20121201”, and a value that is associated with the key, from the second electronic patient-chart information 142. By the retrieval key 10e, information about medicine prescribed for all patients on Dec. 1, 2012 can be retrieved.

After generating a retrieval key, and retrieving a key and a value corresponding to the retrieval key as described above, the retrieving unit 153 outputs a retrieval result to the display unit 130. The retrieving unit 153 may perform various kinds of summarization processing on the retrieval result, and may output a result obtained by performing the summarization processing to the display unit 130.

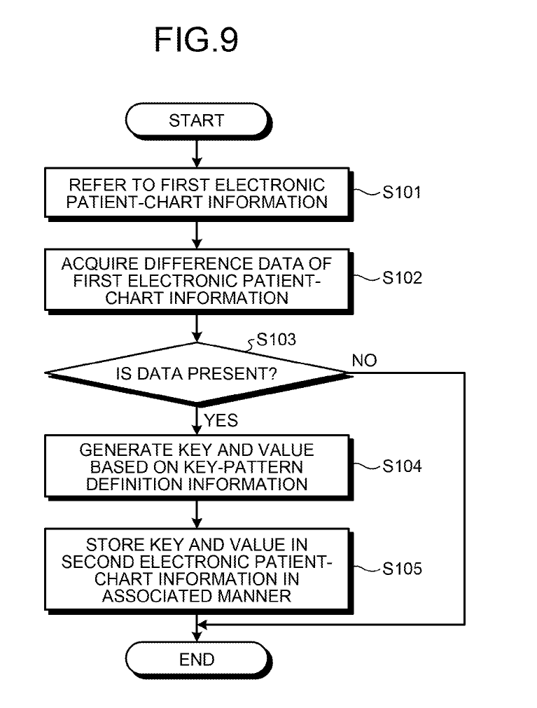

Next, one example of a processing procedure of the retrieval apparatus 100 according to the present embodiment is explained. FIG. 9 is a flowchart indicating a processing procedure of generating the second electronic patient-chart information by the retrieval apparatus. For example, the retrieval apparatus 100 performs processing in FIG. 9 when the first electronic patient-chart information 141 is updated.

As indicated in FIG. 9, the retrieval apparatus 100 refers to the first electronic patient-chart information 141 (step S101), and acquires difference data of the first electronic patient-chart information 141 (step S102). At step S102, the retrieval apparatus 100 acquires the difference data by taking a difference between the first electronic patient-chart information 141 before update and the first electronic patient-chart information 141 after update. The retrieval apparatus 100 ends the processing when there is no data in the difference data (step S103: NO).

On the other hand, when there is data in the difference data (step S103: YES), the retrieval apparatus 100 generates a key and a value based on the key-pattern definition information 143 (step S104). The retrieval apparatus 100 stores the key and the value in the second electronic patient-chart information 142 in an associated manner (step S105).

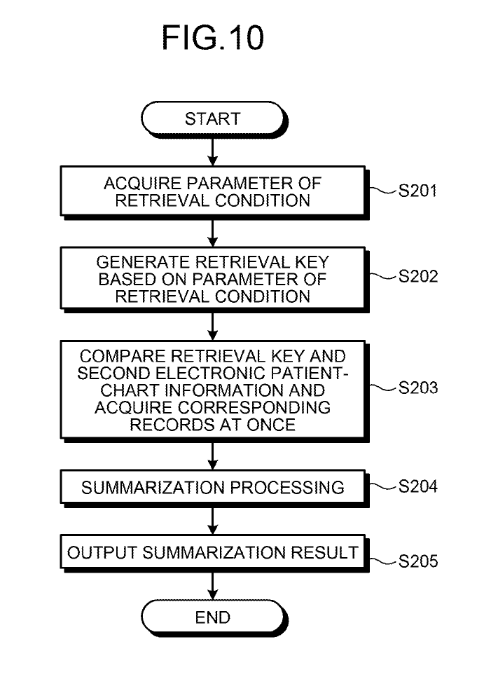

FIG. 10 is a flowchart indicating a processing procedure of retrieving by the retrieval apparatus. For example, the retrieval apparatus 100 performs processing in FIG. 10 when a parameter of a retrieval condition is acquired from the input unit 120.

As indicated in FIG. 10, the retrieval apparatus 100 acquires a parameter of a retrieval condition (step S201). At step S201, as the parameters of a retrieval condition, for example, a retrieval keyword, a date, a patient ID, and the like are included. The retrieval keyword corresponds to the above items “chart, prescription, injection, and the like”.

The retrieval apparatus 100 generates a retrieval key based on the parameter of the retrieval condition (step S202). The retrieval apparatus 100 compares the retrieval key and the second electronic patient-chart information 142, to acquire corresponding records at once (step S203).

The retrieval apparatus 100 performs summarization processing (step S204), and outputs a summarization result (step S205).

Next, an effect of the retrieval apparatus 100 according to the present embodiment is explained. The retrieval apparatus 100 reads information on treatment given to a patient of the patient ID and a date to generate a key, and stores the generated key in the second electronic patient-chart information 142. When accepting a retrieval condition, the retrieval apparatus 100 retrieves data corresponding to the retrieval condition from the second electronic patient-chart information 142. Therefore, according to the retrieval apparatus 100, desired information can be acquired. Moreover, even when various kinds of periods are retrieval targets, just by changing a period in the retrieval condition, information of a patient corresponding to each period can be acquired.

Furthermore, when accepting a retrieval condition, the retrieval apparatus 100 generates a retrieval key from a retrieval condition, and compares the generated retrieval key and the second electronic patient-chart information 142, thereby extracting a record corresponding to the retrieval key. Therefore, a user can retrieve desired information just by specifying a retrieval condition, without generating a complicated command.

Although the retrieval apparatus 100 generates a key and a value based on the first electronic patient-chart information 141, and registers the generated key and value in the second electronic patient-chart information 142 in the embodiment described above, it is not limited thereto. For example, the retrieval apparatus 100 may store information about employees, and may generate a key and a value from the information about employees, to store in a table. The information about employees corresponds to, for example, information in which information identifying an employee, an entrance-exit history of an employee, and a date are associated. For example, the generating unit 151 may generate a key by combining the information identifying an employee, a date, and the entrance-exit history.

Moreover, in the retrieval apparatus 100 described above, although a case in which the first electronic patient-chart information 141 is stored in the memory unit 140 and the second electronic patient-chart information 142 is stored in the same memory unit 140 has been explained, it is not limited thereto. For example, the retrieval apparatus 100 may store the first electronic patient-chart information 141 and the second electronic patient-chart information 142 in respective different databases.

Furthermore, the retrieval apparatus 100 described above may store the first electronic patient-chart information 141 and the second electronic patient-chart information 142 in HBase. Using the function of HBase, even when the first and second electronic patient-chart information 141 and 142 are stored in multiple storage devices in a distributed manner, the first and second electronic patient-chart information 141 and 142 can be handled as information stored in a single storage device.

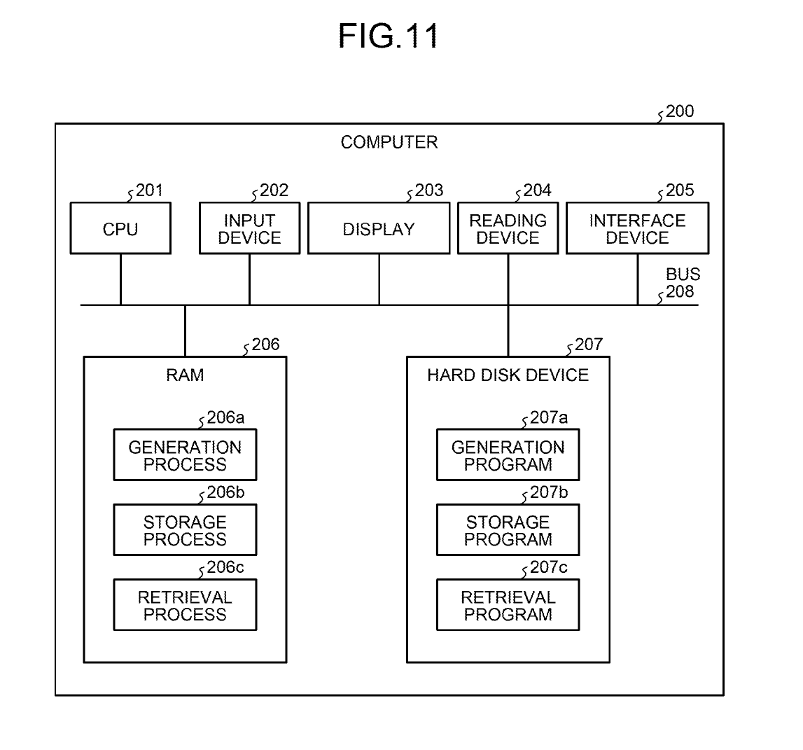

Next, one example of a computer that executes a retrieval program that implements functions similar to those of the retrieval apparatus 100 indicated in the above embodiment is explained. FIG. 11 depicts one example of a computer that executes the retrieval program.

As depicted in FIG. 11, a computer 200 includes a CPU 201 that performs various kinds of calculation processing, an input device 202 that accepts an input of data from a user, and a display 203. Moreover, the computer 200 includes a reading device 204 that reads a program and the like from a storage medium, and an interface device 205 that performs communication of data with other computers through a network. Furthermore, the computer 200 includes a RAM 206 that temporarily stores various kinds of information, and a hard disk device 207. The respective devices 201 to 207 are connected to a bus 208.

The hard disk device 207 has a generation program 207a, a storage program 207b, and a retrieval program 207c. The CPU 201 reads the respective programs 207a to 207c to develop on the RAM 206.

The generation program 207a functions as a generation process 206a. The storage program 207b functions as a storage process 206b. The retrieval program 207c functions as a retrieval process 206c.

For example, the generation process 206a corresponds to the generating unit 151. The storage process 206b corresponds to the storage unit 152. The retrieval process 206c corresponds to the retrieving unit 153.

The respective programs 207a to 207c are not necessarily required to be stored in the hard disk device 207 initially. For example, the respective programs are stored in a “transportable physical medium” such as a flexible disk (FD), a compact-disc read-only memory (CD-ROM), a digital versatile disk (DVD), a magneto-optical disk, and an integrated circuit (IC) card inserted to the computer 200. The respective programs 207a to 207c may be read by the computer 200 to be executed.

According to one embodiment, desired information can be acquired from a databased.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute:
reading information that identifies a user, information about any one of an action performed on the user and an action performed by the user, and date and time information from data base;
generating a data string that is obtained by combining the information that identifies a user, the information about any one of an action performed on the user and an action performed by the user, and the date and time information, for a plurality of data records that are stored in the database;
storing the data strings generated in the generating in a memory;
accepting specification of information that identifies a user, a retrieval target period, and information about an action of the user; and
retrieving a data string corresponding to the specification from among the data strings stored in the memory.

2. The non-transitory computer-readable recording medium according to claim 1, wherein
the generating reads information that identifies a patient, information about treatment given to the patient, and information on a treatment date from a database and generates a data string by combining the information that identifies a patient, the information about treatment given to the patient, and the information on a treatment date, the accepting accepts specification of information that identifies a patient, a retrieval target period, and information about treatment given to the patient and the retrieving retrieves a data string corresponding to the specification from among the data strings stored in the memory.

3. The non-transitory computer-readable recording medium according to claim 2, wherein
the retrieving generates a retrieval key based on information that identifies a patient, a retrieval target period, and information about treatment given to the patient, and retrieves a data string corresponding to the specification based on the retrieval key and the data strings stored in the memory.

4. A retrieval method comprising:
reading information that identifies a user, information about any one of an action performed on the user and an action performed by the user, and date and time information from data base;
generating a data string that is obtained by combining the information that identifies a user, the information about any one of an action performed on the user and an action performed by the user, and the date and time information, for a plurality of data records that are stored in the database;
storing the data strings generated in the generating in a memory;
accepting specification of information that identifies a user, a retrieval target period, and information about an action of the user; and
retrieving a data string corresponding to the specification from among the data strings stored in the memory.

5. A retrieval apparatus comprising:
a memory; and
a processor coupled to the memory, wherein the processor executes a process comprising:
reading information that identifies a user, information about any one of an action performed on the user and an action performed by the user, and date and time information from the memory;
generating a data string that is obtained by combining the information that identifies a user, the information about any one of an action performed on the user and an action performed by the user, and the date and time information, for a plurality of data records that are stored in the memory;
storing the data strings generated in the generating in the memory;
accepting specification of information that identifies a user, a retrieval target period, and information about an action of the user; and
retrieving a data string corresponding to the specification from among the data strings stored in the memory.
